(19) United States
(12) Patent Application Publication
(10) Pub. No.: US 2026/0360777 A1
(43) Pub. Date: Nov. 12, 2026

(54) FUEL CELL STACK

(71) Applicant: HONDA MOTOR CO., LTD., Tokyo (JP)

(72) Inventors: Tomoki HORI, Saitama (JP); Fumiya ARAI, Saitama (JP); Tadashi NISHIYAMA, Saitama (JP); Masaru YOSHIDA, Tokyo (JP)

(21) Appl. No.: 19/556,466

(22) Filed: Mar. 4, 2026

(30) Foreign Application Priority Data
Mar. 12, 2025 (JP) 2025-039719

(51) Int. Cl. H01M 8/04044; H01M 8/04029; H01M 8/241; H01M 8/2483

(52) U.S. Cl. CPC H01M 8/04044; H01M 8/04029; H01M 8/241; H01M 8/2483

(57) ABSTRACT

A fuel cell stack includes: a cell stack body; end units disposed at both ends thereof; and a tube body disposed in a cooling medium discharge flow path. One end unit includes an end portion receiving part for receiving an end portion of the tube body. The end portion receiving part has a bubble discharge hole including: a first part that is provided on a side of the cell stack body, is vertically elongated, displaceably receives the end portion of the tube body, and communicates with an internal passage of the tube body; a second part provided on a side away from the cell stack body, communicating with the first part and the internal passage, and having a vertical dimension greater than the tube body; and an annular contact surface provided at a boundary between the first and second parts and facing one end surface of the tube body.

### TECHNICAL FIELD

The present invention relates to a fuel cell stack.

### BACKGROUND ART

In recent years, research and development are being conducted in relation to fuel cells which can contribute to energy efficiency to ensure that a greater number of people can access reliable, sustainable, and advanced energy at reasonable cost.

A fuel cell stack includes a cell stack body composed of a stack of multiple power generation cells. The fuel cell stack is provided with a cooling medium flow path in which a liquid cooling medium (coolant), such as water, for cooling the cell stack body flows in the stacking direction of the cell stack body. The cooling medium flow path includes a cooling medium discharge flow path for discharging the cooling medium that has cooled the fuel cell stack from the fuel cell stack. In such a fuel cell stack, to capture and discharge bubbles generated in the cooling medium discharge flow path to the outside, a tube body, which is often called an air vent tube, may be disposed in the cooling medium discharge flow path (for example, JP2019-79779A).

The air vent tube extends in the cooling medium discharge flow path in the stacking direction of the power generation cells in the cell stack body, and the both ends thereof are supported by end units disposed at end portions of the fuel cell stack. It is preferable for assembly and manufacture that the air vent tube support structure of the end units is configured to be capable of tolerating a stacking error or the like of the power generation cells of the cell stack body. For this reason, the air vent tube is supported by the end units to be displaceable in the radial direction and the longitudinal direction (the stacking direction of the cell stack body) within a range necessary to tolerate the stacking error or the like.

One end portion of the air vent tube is fitted in a bubble discharge hole formed in the corresponding end unit such that the end portion of the air vent tube is displaceable in the radial direction and the longitudinal direction. The bubbles captured in the air vent tube are discharged from the bubble discharge hole to the outside of the fuel cell stack.

In the fuel cell stack mentioned above, the bubbles in the cooling medium discharge flow path may directly flow to the bubble discharge hole without flowing in the air vent tube. In this case, if the bubble discharge hole is a tapered hole, the air vent tube may be tightly fitted in the bubble discharge hole, and the communication between the upstream side and the downstream side of the bubble discharge hole may be blocked. If such blocking occurs, the bubbles will stay on the upstream side of the bubble discharge hole, and discharge of the bubbles will be hindered.

In the fuel cell stack mentioned above, when the air vent tube is fitted in the bubble discharge hole, an effect of restricting the movement of the air vent tube in the axial direction is obtained, but if the fitting is tight, there is a risk that the air vent tube may become difficult to be pulled out from the bubble discharge hole.

### SUMMARY OF THE INVENTION

In view of the foregoing background, an object of the present invention is to provide a fuel cell stack in which bubbles do not stay in the bubble discharge hole (the tube body) and displacement of the air vent tube in the axial direction is restricted without causing other problems. Moreover, the present invention is intended to contribute to energy efficiency.

To achieve the above object, one aspect of the present invention provides a fuel cell stack, comprising: a cell stack body composed of multiple power generation cells stacked in a predetermined direction; a first end unit and a second end unit respectively disposed at both ends of the cell stack body in a stacking direction thereof; a cooling medium flow path including a cooling medium discharge flow path extending through the cell stack body in the stacking direction of the cell stack body to discharge a cooling medium supplied to the cell stack body to an outside; and a tube body disposed in the cooling medium discharge flow path to extend in the stacking direction and having end portions supported by the first end unit and the second end unit, wherein the first end unit includes an end portion receiving part for receiving a corresponding end portion of the tube body, and the end portion receiving part has a bubble discharge hole extending through the first end unit in the stacking direction, and the bubble discharge hole comprising: a first part that is provided on a side of the cell stack body, is larger than an outer shape of the tube body, is vertically elongated, receives the corresponding end portion of the tube body to be displaceable in the stacking direction of the cell stack body and a direction perpendicular to the stacking direction, and communicates with an internal passage of the tube body; a second part that is provided on a side away from the cell stack body, communicates with the first part and the internal passage, includes a part smaller than the outer shape of the tube body, and has a vertical dimension greater than a vertical dimension of the tube body; and an annular contact surface provided at a boundary between the first part and the second part and facing one end surface of the tube body.

According to the present invention, bubbles do not stay in the bubble discharge hole and displacement of the tube body in the axial direction is restricted without causing other problems.

### BRIEF DESCRIPTION OF THE DRAWINGS

FIG. 1 is a perspective view schematically showing an overall configuration of a fuel cell stack according to an embodiment;

FIG. 2 is a vertical sectional view of the fuel cell stack according to the embodiment;

FIG. 3 is an enlarged vertical sectional view of a main part of the fuel cell stack according to the embodiment;

FIG. 4 is a sectional view taken along line IV-IV in FIG. 3;

FIG. 5 is a sectional view taken along line IV-IV in FIG. 3, with a tube body being removed;

FIG. 6 is a sectional view taken along line IV-IV in FIG. 3 and shows a displacement of the tube body; and

FIG. 7 is an enlarged vertical sectional view of the main part showing an upward displacement of the tube body.

### DETAILED DESCRIPTION OF THE INVENTION

In the following, an embodiment of a fuel cell stack 10 will be described with reference to the drawings. Note that in the following description, three orthogonal axes in the front-rear direction, the left-right direction, and the up-down direction are defined as shown in the drawings.

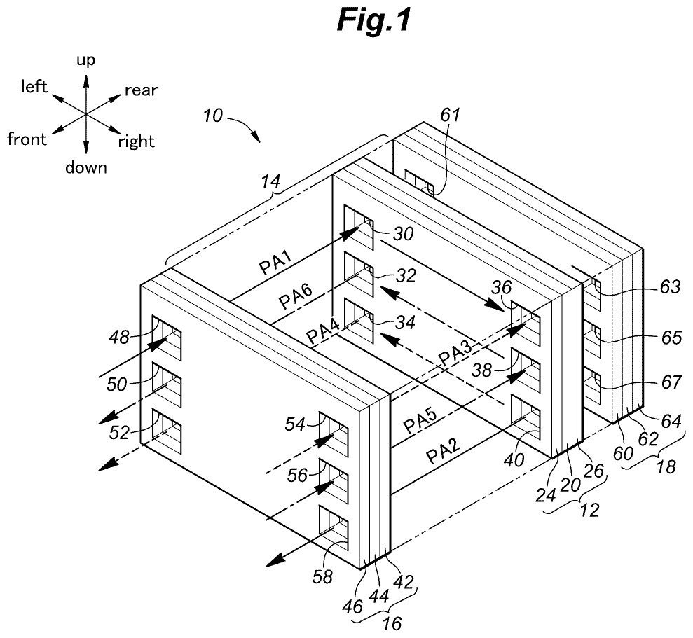

First, an overall structure of the fuel cell stack 10 will be described with reference to FIG. 1. The fuel cell stack 10 includes a cell stack body 14 composed of multiple power generation cells 12 stacked in the front-rear direction (predetermined direction), a wet-side end unit 16 (the first end unit) disposed at one end portion of the cell stack body 14 in the stacking direction, and a dry-side end unit 18 (the second end unit) disposed at the other end portion of the cell stack body 14 in the stacking direction. The wet-side end unit 16 and the dry-side end unit 18 are fastened to the cell stack body 14 in the stacking direction by means of fastening members not shown in the drawings, and they are contained in a stack case not shown in the drawings.

The fuel cell stack 10 is supplied with hydrogen gas (fuel gas) and oxidizer gas (air) as reaction gases.

In the following description, the stacking direction of the cell stack body 14 may be referred to as the front-rear direction.

Each power generation cell 12 includes an electrolyte membrane-electrode structure 20 having a rectangular plate shape, a first separator 24 disposed on one side of the electrolyte membrane-electrode structure 20, and a second separator 26 disposed on the other side of the electrolyte membrane-electrode structure 20. A left edge part of each power generation cell 12 is formed with a hydrogen gas supply opening 30, a coolant discharge opening 32, and an oxidizer gas discharge opening 34 arranged in order from above and each extending through the power generation cell 12 in the stacking direction. A right edge part of each power generation cell 12 is formed with an oxidizer gas supply opening 36, a coolant supply opening 38, and a hydrogen gas discharge opening 40 arranged in order from above and each extending through the power generation cell 12 in the stacking direction.

The wet-side end unit 16 includes a terminal plate 42, an electrical insulation plate 44, and an end plate 46 which are stacked in order from the side of the power generation cells 12. A left edge part of the wet-side end unit 16 is formed with a hydrogen gas supply opening 48, a coolant discharge opening 50, and an oxidizer gas discharge opening 52 arranged in order from above and each extending through the wet-side end unit 16 in the front-rear direction. A right edge part of the wet-side end unit 16 is formed with an oxidizer gas supply opening 54, a coolant supply opening 56, and a hydrogen gas discharge opening 58 arranged in order from above and each extending through the wet-side end unit 16 in the front-rear direction. The openings provided in the wet-side end unit 16 are in the same arrangement as the openings provided in each power generation cell 12 and each communicate with a corresponding one of the hydrogen gas supply opening 30, the hydrogen gas discharge opening 40, the oxidizer gas supply opening 36, the oxidizer gas discharge opening 34, the coolant supply opening 38, and the coolant discharge opening 32 of the power generation cell 12.

The hydrogen gas supply opening 48 communicates with the hydrogen gas supply opening 30 of the power generation cell 12. The coolant discharge opening 50 communicates with the coolant discharge opening 32 of the power generation cell 12. The oxidizer gas discharge opening 52 communicates with the oxidizer gas discharge opening 34 of the power generation cell 12. The oxidizer gas supply opening 54 communicates with the oxidizer gas supply opening 36 of the power generation cell 12. The coolant supply opening 56 communicates with the coolant supply opening 38 of the power generation cell 12. The hydrogen gas discharge opening 58 communicates with the hydrogen gas discharge opening 40 of the power generation cell 12.

The dry-side end unit 18 includes a terminal plate 60, an electrical insulation plate 62, and an end plate 64 which are stacked in order from the side of the power generation cells 12. The terminal plate 60 and the electrical insulation plate 62 are formed with a hydrogen gas supply opening 61, a hydrogen gas discharge opening 67, an oxidizer gas supply opening 63, an oxidizer gas discharge opening (not shown in the drawings), a coolant supply opening 65, and a coolant discharge opening (not shown in the drawings) arranged in the same manner as the openings of the wet-side end unit 16 and each extending through the terminal plate 60 and the electrical insulation plate 62 in the front-rear direction. Note that the end plate 64 is not formed with these openings. The openings provided in the dry-side end unit 18 are in the same arrangement as the openings provided in each power generation cell 12 and each communicate with a corresponding one of the hydrogen gas supply opening 30, the hydrogen gas discharge opening 40, the oxidizer gas supply opening 36, the oxidizer gas discharge opening 34, the coolant supply opening 38, and the coolant discharge opening 32 of the power generation cell 12.

Thereby, the hydrogen gas flows in the stacking direction of the cell stack body 14 through a gas supply flow path PA1 to be supplied to each power generation cell 12. The hydrogen off-gas (exhaust gas) generated at each power generation cell 12 flows from each power generation cell 12 in the stacking direction of the cell stack body 14 through an exhaust gas flow path PA2.

The oxidizer gas may be air and flows in the stacking direction of the cell stack body 14 through a gas supply flow path PA3 to be supplied to each power generation cell 12. The oxidizer off-gas (exhaust gas) generated at each power generation cell 12 flows from each power generation cell 12 in the stacking direction of the cell stack body 14 through an exhaust gas flow path PA4.

The coolant (cooling medium) may be a liquid including water or the like and flows in the stacking direction of the cell stack body 14 through a coolant supply flow path PA5 to be supplied to each power generation cell 12 to cool each power generation cell 12. The coolant discharged from each power generation cell 12 flows in the stacking direction of the cell stack body 14 through a coolant discharge flow path PA6 (cooling medium discharge flow path).

In the fuel cell stack 10, electron and water are generated by the electrochemical reaction of the hydrogen gas and the oxidizer gas supplied to each power generation cell 12, and electric power is taken out from the terminal plates 42 and 60. The water generated in the fuel cell stack 10 is discharged to the outside of the fuel cell stack 10 through the exhaust gas flow paths PA2 and PA4.

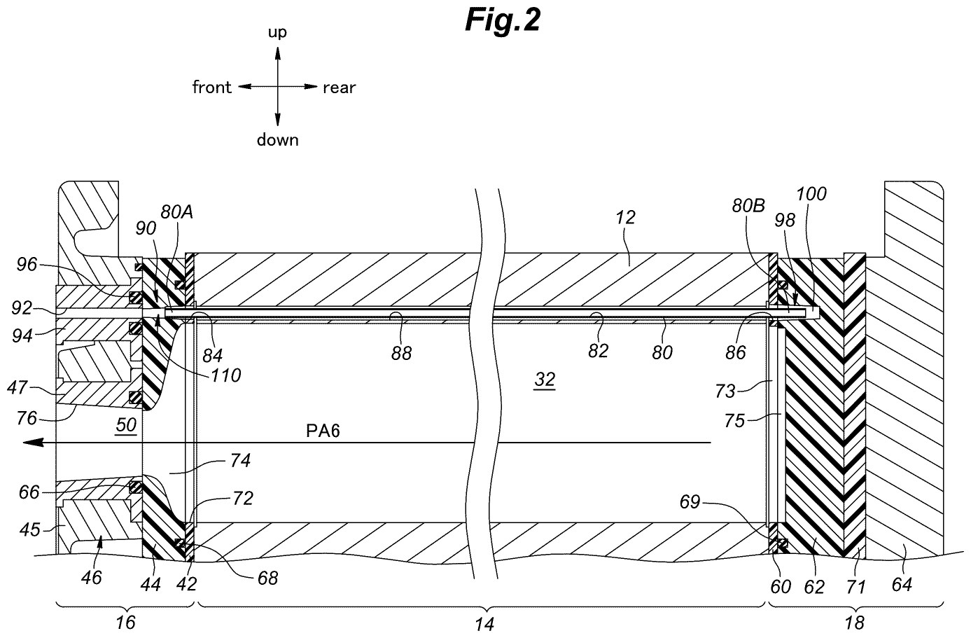

Next, details of the coolant discharge flow path PA6 of the fuel cell stack 10 and the structure related to the coolant discharge flow path PA6 will be described with reference to FIG. 2 to FIG. 7. Note in that FIG. 2 to FIG. 7, elements corresponding to those shown in FIG. 1 are denoted by the same reference signs as in FIG. 1, and the description thereof will be omitted.

As shown in FIG. 2, the end plate 46 of the wet-side end unit 16 includes a port arrangement plate 45 and a port member 47 mounted in the port arrangement plate 45. An airtight seal member 66 is provided between the port member 47 and the electrical insulation plate 44. An airtight seal member 68 is provided between the electrical insulation plate 44 and the terminal plate 42.

The terminal plate 42, the electrical insulation plate 44, and the port member 47 of the wet-side end unit 16 are respectively formed with through holes 72, 74, and 76 which constitute the coolant discharge opening 50.

An airtight seal member 69 is provided between the terminal plate 60 and the electrical insulation plate 62 of the dry-side end unit 18. A gasket 71 is provided between the electrical insulation plate 62 and the end plate 64. The terminal plate 60 of the dry-side end unit 18 is formed with a through hole 73 constituting the coolant discharge opening of the dry-side end unit 18. The electrical insulation plate 62 is formed with a non-through hole 75 constituting the coolant discharge opening of the dry-side end unit 18.

A tube body 80 is disposed in the coolant discharge flow path PA6. The tube body 80 is an air vent tube that captures bubbles in the coolant flowing in the coolant discharge flow path PA6 and discharges the bubbles to the outside. The tube body 80 extends in an upper portion of the coolant discharge flow path PA6 substantially horizontally in the stacking direction of the cell stack body 14, namely, in the front-rear direction. The tube body 80 has a cylindrical shape and includes an internal passage 82 having openings at both ends.

The terminal plate 42 of the wet-side end unit 16 is formed with a support hole 84 to extend therethrough in the stacking direction of the cell stack body 14. The terminal plate 60 of the dry-side end unit 18 is formed with a support hole 86 to extend therethrough in the stacking direction of the cell stack body 14. The front end portion of the tube body 80 extends through the support hole 84 of the terminal plate 42 and thereby is supported by the wet-side end unit 16. The rear end portion of the tube body 80 extends through the support hole 86 of the terminal plate 60 and thereby is supported by the dry-side end unit 18.

A part of the cell stack body 14 constituting an upper side of the coolant discharge opening 32 is formed with a through hole 88 extending therethrough in the stacking direction of the cell stack body 14. The tube body 80 is inserted in the through hole 88 between the wet-side end unit 16 and the dry-side end unit 18. As will be described later, the through hole 88 is connected to the coolant discharge flow path PA6, namely, forms a part of the coolant discharge flow path PA6.

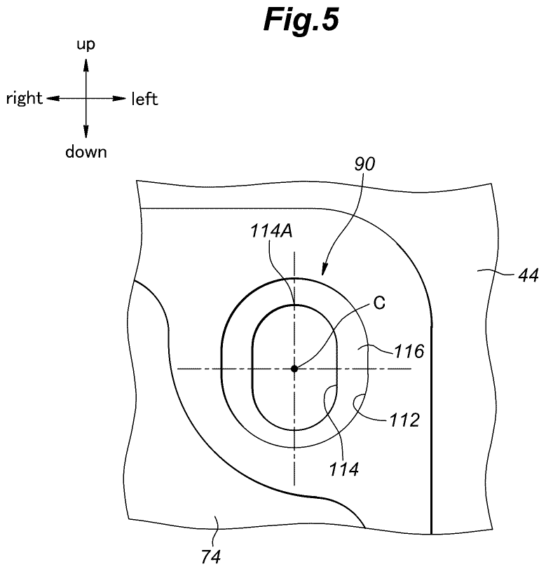

The support holes 84 and 86 and the through hole 88 are arranged on the same axis and have inner diameters greater than the outer diameter R1 of the tube body 80 (see FIG. 5). In other words, the inner diameters of the support holes 84 and 86 and the through hole 88 are greater than the outer shape of the tube body 80 determined by the outer diameter R1. Thereby, the tube body 80 is loosely fitted in the support holes 84 and 86 and the through hole 88 and is displaceable relative to the wet-side end unit 16 and the dry-side end unit 18 in the axial direction and the radial direction.

The electrical insulation plate 44 of the wet-side end unit 16 is formed with a front end receiving part 90 for receiving the front end 80A of the tube body 80. The electrical insulation plate 62 of the dry-side end unit 18 is formed with a rear end receiving part 98 for receiving the rear end 80B of the tube body 80. The rear end receiving part 98 includes a recessed part 100 that opens toward the support hole 86 of the terminal plate 60.

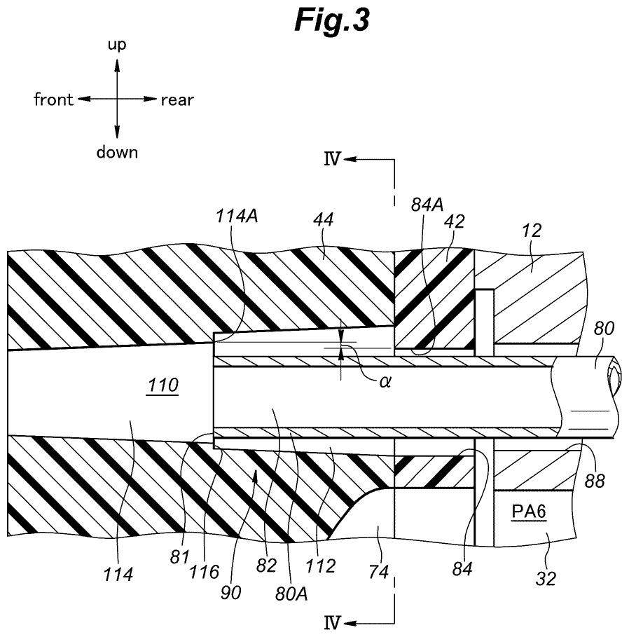

Details of the front end receiving part 90 will be described with reference to FIG. 3 to FIG. 7.

The front end receiving part 90 has a bubble discharge hole 110 extending through the electrical insulation plate 44 in the stacking direction of the cell stack body 14. The bubble discharge hole 110 includes a first part 112 provided on the side of the cell stack body 14 and a second part 114 provided on the side away from the cell stack body 14, namely, on the side of the end plate 46.

The first part 112 and the second part 114 are in communication with each other. The first part 112 is in communication with the support hole 84 of the terminal plate 42 on the side of the cell stack body 14. The second part 114 is in communication with a coolant discharge port 92 of a port member 94 provided in the port arrangement plate 45 on the side opposite from the cell stack body 14 (see FIG. 2). Between the port member 94 and the electrical insulation plate 44, an airtight seal member 96 is provided.

The first part 112 has an oval or elliptical cross-sectional shape that is vertically elongated, is tapered to be narrower toward the second part 114, and communicates with the second part 114 and the internal passage 82 of the tube body 80.

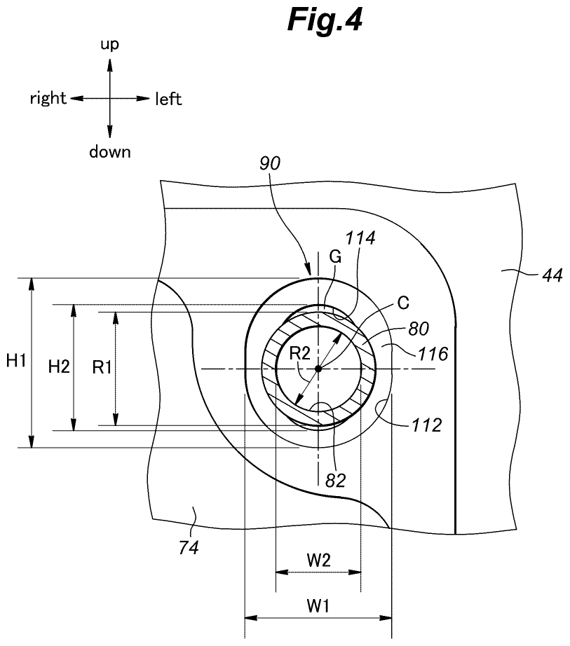

As shown in FIG. 4, the first part 112 has a vertical dimension H1 and a lateral dimension W1 (the dimension in the left-right direction) greater than the outer shape, namely, the outer diameter R1 of the tube body 80. In other words, H1>R1 and W1>R1. Thereby, the first part 112 receives the front end 80A of the tube body 80 to be displaceable in the stacking direction of the cell stack body 14 (the axial direction) and directions perpendicular to the stacking direction (the up-down direction and the left-right direction).

The second part 114 has an oval or elliptical cross-sectional shape that is vertically elongated, is tapered to be narrower toward the coolant discharge port 92 (see FIG. 2), and communicates with the first part 112 and the coolant discharge port 92.

As shown in FIG. 4, the second part 114 has a vertical dimension H2 greater than the outer shape (namely, the outer diameter R1 of the tube body 80) and a lateral dimension W2 (the dimension in the left-right direction) smaller than the outer diameter R1. In other words, H2>R1 and W2<R1. Thereby, the tube body 80 has portions located outside the second part 114 on both left and right sides.

Note that the lateral dimension W1 and the vertical dimension H1 of the first part 112 are dimensions of the tapered shape of the first part 112 on the expanded end side (on the side of the cell stack body 14). The vertical dimension H2 and the lateral dimension W2 of the second part 114 are dimensions of the tapered shape of the second part 114 on the expanded end side (on the side of the first part 112).

The front end receiving part 90 has, at the boundary between the first part 112 and the second part 114, a contact surface 116 in an oval annular shape that is vertically elongated. The contact surface 116 is a plane that faces the front end surface 81 of the tube body 80, has an outline larger than the outline (the outer diameter R1) of the front end surface 81 of the tube body 80, has an oval or elliptical annular shape that is vertically elongated, and extends in a direction perpendicular to the stacking direction of the cell stack body 14.

The front end surface 81 of the tube body 80 can contact the contact surface 116 by undergoing displacement in the axial direction relative to the cell stack body 14. Due to this contact, the tube body 80 cannot enter the second part 114, and the axial displacement thereof toward the wet-side end unit 16, in other words, forward is restricted.

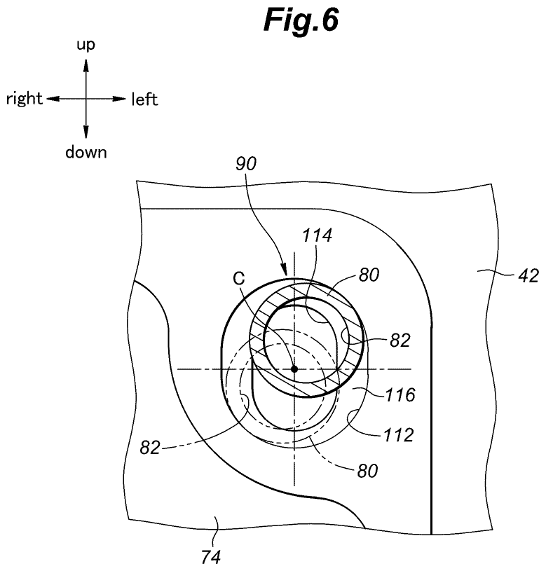

The center position C of the first part 112 and the center position C of the second part 114 are the same as each other and, as shown in FIG. 6, are located at a position included in the internal passage 82 of the tube body 80 as viewed in the stacking direction of the cell stack body 14 irrespective of the displacement of the tube body 80 in the up-down direction and the left-right direction relative to the electrical insulation plate 44 (the wet-side end unit 16).

As shown in FIG. 4, a half of the difference (H1−H2) between the vertical dimension H1 of the first part 112 and the vertical dimension H2 (expanded end side dimension) of the second part 114 is smaller than the inner diameter R2 of the tube body 80. A half of the difference (W1−W2) between the lateral dimension W1 of the first part 112 and the lateral dimension W2 of the second part 114 is smaller than the inner diameter R2 of the tube body 80. In other words, (H1−H2)/2<R2 and (W1−W2)/2<R2.

Since the second part 114 has a vertical dimension H2 greater than the outer diameter R1 (vertical dimension) of the tube body 80, a gap G (see FIG. 4) is created on a part of the contact surface 116 irrespective of the displacement of the tube body 80 relative to the wet-side end unit 16.

The support hole 84 of the terminal plate 42 is a straight hole having a circular cross-sectional shape. An upper edge 84A of the support hole 84 defines an upper limit of the movement of the tube body 80 in the up-down direction relative to the cell stack body 14 by contacting the tube body 80. As shown in FIG. 3, the upper edge 84A of the support hole 84 is located lower than the upper edge 114A of the second part 114 at the boundary with the first part 112 (on the expanded end side) by a vertical dimension α. Thereby, even when the tube body 80 comes into contact with the contact surface 116 and the tube body 80 is displaced to the upper limit position where the tube body 80 contacts the upper edge 84A of the support hole 84, it is ensured that the gap G having the vertical dimension α is created between the upper edge 114A of the inner peripheral surface of the second part 114 and the outer peripheral surface of the tube body 80.

According to the above configuration, the bubbles contained in the coolant that is going to flow to the coolant discharge flow path PA6 from the coolant supply flow path PA5 after cooling the cell stack body 14 are captured by and flow into the internal passage 82 of the tube body 80 from the recessed part 100 provided in the rear end receiving part 98 of the dry-side end unit 18. These bubbles flow in the internal passage 82 toward the wet-side end unit 16, and further flow through the bubble discharge hole 110 of the wet-side end unit 16 to be discharged from the coolant discharge port 92 to the outside.

By the contact of the front end surface 81 of the tube body 80 with the contact surface 116, the forward axial displacement of the tube body 80 relative to the wet-side end unit 16 is restricted. This restriction is performed in a state in which the tube body 80 is loosely fitted in the first part 112 such that the outer peripheral surface of the tube body 80 is not tightly fitted in the inner peripheral surface of the first part 112, and thus, the restriction is achieved without causing problems such as that the tube body 80 becomes difficult to be pulled out from the bubble discharge hole 110.

Since the center position C of the second part 114 is located at a position included in the internal passage 82 of the tube body 80 as viewed in the stacking direction of the cell stack body 14, even when the tube body 80 is displaced to the upper left relative to the cell stack body 14 as shown by a solid line in FIG. 6 or the tube body 80 is displaced to the lower right relative to the wet-side end unit 16 as shown by a virtual line in FIG. 6, the communication between the internal passage 82 of the tube body 80 and the second part 114 is maintained.

Further, since (H1−H2)/2<R2 and (W1−W2)/2<R2, regardless of whether the tube body 80 is displaced relative to the wet-side end unit 16 in the vertical or horizontal direction (including diagonal directions), the internal passage 82 is not closed by the contact of the tube body 80 with the contact surface 116 and the communication between the internal passage 82 of the tube body 80 and the second part 114 is maintained.

Accordingly, regardless of whether the tube body 80 is displaced relative to the wet-side end unit 16 in the vertical or horizontal direction (including diagonal directions), the bubbles flowing in the internal passage 82 of the tube body 80 move from the internal passage 82 to the coolant discharge port 92 and the discharge of bubbles is not hindered.

Since the vertical dimension H2 of the second part 114 is greater than the outer diameter R1 (vertical dimension) of the tube body 80, when the front end surface 81 of the tube body 80 contacts the contact surface 116, the communication between the first part 112 and the second part 114 is ensured by the gap G regardless of the displacement of the tube body 80 in the up-down direction and the lateral direction. Thereby, the bubbles entering the first part 112 from the coolant discharge flow path PA6 through the support hole 84 of the terminal plate 42 without flowing in the tube body 80 flow to the second part 114 and are discharged to the outside.

In other words, when the front end surface 81 of the tube body 80 contacts the contact surface 116, there is always the gap G between the outer peripheral surface of the tube body 80 and the inner peripheral surface of the second part 114, whereby regardless of the displacement of the tube body 80, the bubbles entering the first part 112 flows to the second part 114 through the gap G and is discharged to the outside without staying in the first part 112.

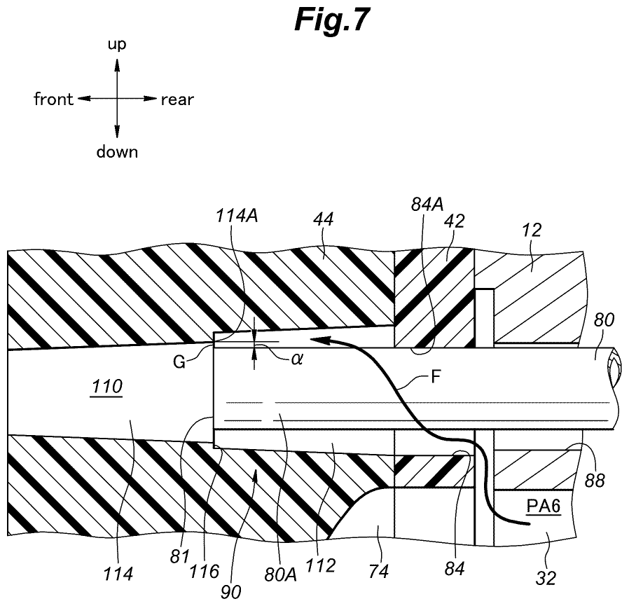

Since the upper edge 84A of the support hole 84 is located lower than the upper edge 114A of the second part 114 at the boundary with the first part 112 by the vertical dimension α, even when the front end surface 81 of the tube body 80 contacts the contact surface 116 and the tube body 80 is displaced to the upper limit position where the tube body 80 contacts the upper edge 84A of the support hole 84 as shown in FIG. 7, the gap G for enabling the communicate between the first part 112 and the second part 114 is maintained on the upper side the tube body 80, and a space with a size suitable for capturing the bubbles and allowing the bubbles to flow smoothly is maintained in a part of the first part 112 on the upper side of the tube body 80.

When the fuel cell stack 10 is tilted in a direction such that the wet-side end unit 16 is positioned higher and the bubbles in the coolant flowing in the coolant discharge flow path PA6 move toward the wet-side end unit 16, bubbles that flow from the support hole 84 of the terminal plate 42 to the first part 112 occur. These bubbles flow as shown by a streamline F in FIG. 7 and gather in an upper portion of the first part 112 and captured in the upper portion of the first part 112. The bubbles captured in the upper portion of the first part 112 smoothly flow in the first part 112 to the second part 114 through the gap G. Thus, even when the fuel cell stack 10 is tilted in a direction such that the wet-side end unit 16 is positioned higher, the bubbles in the coolant are favorably discharged to the outside.

Further, since a space with a size suitable for allowing the bubbles to flow smoothly is maintained in a part of the first part 112 on the upper side of the tube body 80, the bubbles gathering in the first part 112 flow to the second part 114 through the gap G without staying in the first part 112. Due to this also, the bubbles in the coolant are favorably discharged to the outside.

The embodiments may be modified in various ways without being limited to the above-described configurations. For example, the cross-sectional shape of the first part 112 and the second part 114 of the bubble discharge hole 110 may be an oblong rectangular shape that is elongated vertically or the like. It is possible that the first part 112 is a tapered hole while the second part 114 is a straight hole, or that the first part 112 and the second part 114 are both straight holes. The tube body 80 may be an elliptical tubular body or a polygonal tubular body.

The conditions (H1−H2)/2<R2 and (W1−W2)/2<R2 may be achieved by limiting the displacement of the tube body 80 relative to the wet-side end unit 16 with stoppers and setting the effective vertical dimension and lateral dimension of them.

The above embodiments may be summarized as follows.

One embodiment is a fuel cell stack 10, comprising: a cell stack body 14 composed of multiple power generation cells 12 stacked in a predetermined direction; a wet-side end unit 16 (the first end unit) and a dry-side end unit 18 (the second end unit) respectively disposed both ends of the cell stack body 14 in the stacking direction thereof; a cooling medium flow path including a coolant discharge flow path PA6 (cooling medium discharge flow path) extending through the cell stack body 14 in the stacking direction of the cell stack body 14 to discharge a cooling medium supplied to the cell stack body 14 to an outside; and a tube body 80 disposed in the coolant discharge flow path PA6 to extend in the stacking direction and having a front end 80A and a rear end 80B (end portions) supported by the wet-side end unit 16 and the dry-side end unit 18, wherein the wet-side end unit 16 includes a front end receiving part 90 (end portion receiving part) for receiving a front end 80A of the tube body 80, and the front end receiving part 90 has a bubble discharge hole 110 extending through the wet-side end unit 16 in the stacking direction, the bubble discharge hole 110 comprising: a first part 112 that is provided on a side of the cell stack body, is larger than an outer shape of the tube body 80, is vertically elongated, receives the front end 80A (end portion) of the tube body 80 to be displaceable in the stacking direction of the cell stack body 14 and a direction perpendicular to the stacking direction, and communicates with an internal passage 82 of the tube body 80; a second part 114 that is provided on a side away from the cell stack body 14, communicates with the first part 112 and the internal passage 82, includes a part smaller than the outer shape of the tube body 80, and has a vertical dimension H2 greater than an outer diameter R1 (vertical dimension) of the tube body 80; and an annular contact surface 116 provided at a boundary between the first part 112 and the second part 114 and facing the front end surface 81 (one end surface) of the tube body 80 so that the front end surface 81 of the tube body 80 can contact the annular contact surface 116.

According to this aspect, since the second part 114 of the bubble discharge hole 110 has a vertical dimension greater than the vertical dimension of the tube body 80, even when the front end surface 81 of the tube body 80 contacts the contact surface 116, the communication between the first part 112 and the second part 114 is ensured and the bubbles are discharged to the outside without staying in the bubble discharge hole 110. By the contact of the front end surface 81 of the tube body 80 with the contact surface 116, the axial displacement of the tube body 80 relative to the wet-side end unit 16 is restricted without the tube body 80 being tightly fitted in the firs part 112. Thereby, the restriction of the axial displacement of the tube body 80 is achieved without causing problems such as that the tube body 80 becomes difficult to be pulled out from the bubble discharge hole 110.

In the above aspect, preferably, the center position C of the second part 114 is located at a position included in the internal passage 82 as viewed in the stacking direction of the cell stack body 14.

According to this aspect, even when the tube body 80 is displaced relative to the wet-side end unit 16 in a radial direction including the up-down direction, the communication between the second part 114 and the internal passage 82 is ensured.

In the above aspect, preferably, the wet-side end unit 16 has a support hole 84 for the tube body 80, the tube body 80 extending through the support hole 84, the support hole 84 is larger than the outer shape of the tube body 80, and an upper edge 84A of the support hole 84 is located lower than an upper edge 114A of the second part 114 at a boundary with the first part 112.

According to this aspect, a large space is maintained in the upper portion of the first part 112 where the bubbles gather, whereby the bubbles are favorably captured in the upper portion of the first part 112 and accordingly, the bubbles are favorably discharged.

In the above aspect, preferably, the tube body 80 has a cylindrical shape, the first part 112 and the second part 114 have an oval or elliptical cross-sectional shape that is vertically elongated, and the contact surface 116 has an oval or elliptical shape that is vertically elongated.

According to this aspect, when the tube body 80 is displaced in the up-down direction relative to the wet-side end unit 16, discharge of bubbles is reliably ensured and the front end surface 81 of the tube body 80 can stably contact the contact surface 116.

In the above aspect, preferably, the wet-side end unit 16 includes a terminal plate 42, an electrical insulation plate 44, and an end plate 46 in order from a side of the cell stack body 14, the bubble discharge hole 110 is provided in the electrical insulation plate 44, and the terminal plate 42 is provided with a support hole 84 that supports the tube body 80 to be displaceable in the stacking direction and the direction perpendicular to the stacking direction.

According to this aspect, the reception of the front end 80A of the tube body 80 and the support of the tube body 80 are separately performed by the electrical insulation plate 44 and the terminal plate 42.

1. A fuel cell stack, comprising:
a cell stack body composed of multiple power generation cells stacked in a predetermined direction;
a first end unit and a second end unit respectively disposed at both ends of the cell stack body in a stacking direction thereof;
a cooling medium flow path including a cooling medium discharge flow path extending through the cell stack body in the stacking direction of the cell stack body to discharge a cooling medium supplied to the cell stack body to an outside; and
a tube body disposed in the cooling medium discharge flow path to extend in the stacking direction and having end portions supported by the first end unit and the second end unit,
wherein the first end unit includes an end portion receiving part for receiving a corresponding end portion of the tube body, and the end portion receiving part has a bubble discharge hole extending through the first end unit in the stacking direction, and
the bubble discharge hole comprising:
a first part that is provided on a side of the cell stack body, is larger than an outer shape of the tube body, is vertically elongated, receives the corresponding end portion of the tube body to be displaceable in the stacking direction of the cell stack body and a direction perpendicular to the stacking direction, and communicates with an internal passage of the tube body;
a second part that is provided on a side away from the cell stack body, communicates with the first part and the internal passage, includes a part smaller than the outer shape of the tube body, and has a vertical dimension greater than a vertical dimension of the tube body; and
an annular contact surface provided at a boundary between the first part and the second part and facing one end surface of the tube body.

2. The fuel cell stack according to claim 1, wherein a center position of the second part is located at a position included in the internal passage as viewed in the stacking direction of the cell stack body.

3. The fuel cell stack according to claim 1, wherein the first end unit has a support hole for the tube body, the tube body extending through the support hole,
the support hole is larger than the outer shape of the tube body, and
an upper edge of the support hole is located lower than an upper edge of a boundary between the first part and the second part.

4. The fuel cell stack according to claim 1, wherein the tube body has a cylindrical shape,
the first part and the second part have an oval or elliptical cross-sectional shape that is vertically elongated, and
the contact surface has an oval or elliptical annular shape.

5. The fuel cell stack according to claim 4, wherein the first end unit includes a terminal plate, an electrical insulation plate, and an end plate in order from a side of the cell stack body,
the bubble discharge hole is provided in the electrical insulation plate, and
the terminal plate is provided with a support hole that supports the tube body to be displaceable in the stacking direction and the direction perpendicular to the stacking direction.
